(19) United States
(12) Patent Application Publication
(10) Pub. No.: US 2023/0016338 A1
(43) Pub. Date: Jan. 19, 2023

(54) CONTENT DISPLAY METHOD

(71) Applicant: NEC Corporation, Minato-ku, Tokyo (JP)

(72) Inventor: Chisato OKAWA, Tokyo (JP)

(73) Assignee: NEC Corporation, Minato-ku, Tokyo (JP)

(21) Appl. No.: 17/783,075

(22) PCT Filed: Dec. 24, 2019
(86) PCT No.: PCT/JP2019/050603

§ 371 Date: Jun. 7, 2022

(51) Int. Cl. G06Q 30/02; G09F 9/30

(52) U.S. Cl. CPC G06Q 30/0269; G06Q 30/0272; G06Q 30/0261; G09F 9/30

(57) ABSTRACT

A content display system according to the present invention includes a content output unit configured to output content from a display medium and a detecting unit configured to detect a status of a preset target. Then, the content output unit is configured to, in a case where the status of the target satisfies a preset switching condition, perform a switching process to switch the content output from the display medium to other content, and furthermore, in a case of performing a plurality of switching processes, perform at least switching processes for which different switching conditions are set.

### TECHNICAL FIELD

The present invention relates to a content display method, a content display system and a program for displaying content on digital signage.

### BACKGROUND ART

As an advertising method for promoting a product or service to a user, there is a method using digital signage. Digital signage is display mediums, such as a display and a projector, that display content in the form of digital data such as a video, an image, and a character. Since content to display can be easily switched on digital signage, it is common to share a certain advertising time among a plurality of contents to switch and display the plurality of contents.

Further, in recent years, with the development of recognition technology, it is performed to extract the characteristic of a person from the appearance of the person and display content appropriate for the characteristic of the person. This makes it possible to display content expected to have a high advertising effect on a viewer from among a plurality of contents. As an example, Patent Document 1 describes estimating the age and gender of a person by using an image capture device and selecting content to present to the person based on the estimated attributes.
Patent Document 1: Japanese Unexamined Patent Application Publication No. JP-A 2003-271084

However, by the abovementioned technique, only one content appropriate for a recognized person's attribute can be provided. As a result, there arises a problem that an advertising effect by content cannot be further increased.

### SUMMARY

Accordingly, an object of the present invention is to provide a content display method which can solve the abovementioned problem that an advertising effect cannot be further increased.

A content display method as an aspect of the present invention includes: outputting content from a display medium and also detecting a status of a preset target; in a case where the status of the target satisfies a preset switching condition, performing a switching process to switch the content output from the display medium to other content; and furthermore, in a case of performing a plurality of switching processes, performing at least two switching processes for which different switching conditions are set.

Further, a content display system as an aspect of the present invention includes: a content output unit configured to output content from a display medium; and a detecting unit configured to detect a status of a preset target. The content output unit is configured to, in a case where the status of the target satisfies a preset switching condition, perform a switching process to switch the content output from the display medium to other content, and furthermore, in a case of performing a plurality of switching processes, perform at least switching processes for which different switching conditions are set.

Further, a computer program as an aspect of the present invention includes instructions for causing a processor of an information processing apparatus to execute: outputting content from a display medium and also detecting a status of a preset target; in a case where the status of the target satisfies a preset switching condition, performing a switching process to switch the content output from the display medium to other content; and furthermore, in a case of performing a plurality of switching processes, performing at least two switching processes for which different switching conditions are set.

With the configurations as described above, the present invention can further increase an advertising effect by content displayed on a display medium.

### BRIEF DESCRIPTION OF DRAWINGS

FIG. 1 is a block diagram showing an overall configuration of a content display system according to a first example embodiment of the present invention;

FIG. 2 is a block diagram showing a configuration of a control apparatus disclosed in FIG. 1;

FIG. 3 is a view showing an image of switching content to output by the control apparatus disclosed in FIG. 1;

FIG. 4 is a view showing an image of switching content to output by the control apparatus disclosed in FIG. 1;

FIG. 5 is a view showing an image of switching content to output by the control apparatus disclosed in FIG. 1;

FIG. 6 is a flowchart showing an operation of the control apparatus disclosed in FIG. 1;

FIG. 7 is a block diagram showing a hardware configuration of a content display system according to a second example embodiment of the present invention;

FIG. 8 is a block diagram showing a configuration of the content display system according to the second example embodiment of the present invention; and

FIG. 9 is a flowchart showing an operation of the content display system according to the second example embodiment of the present invention.

### EXAMPLE EMBODIMENTS

### First Example Embodiment

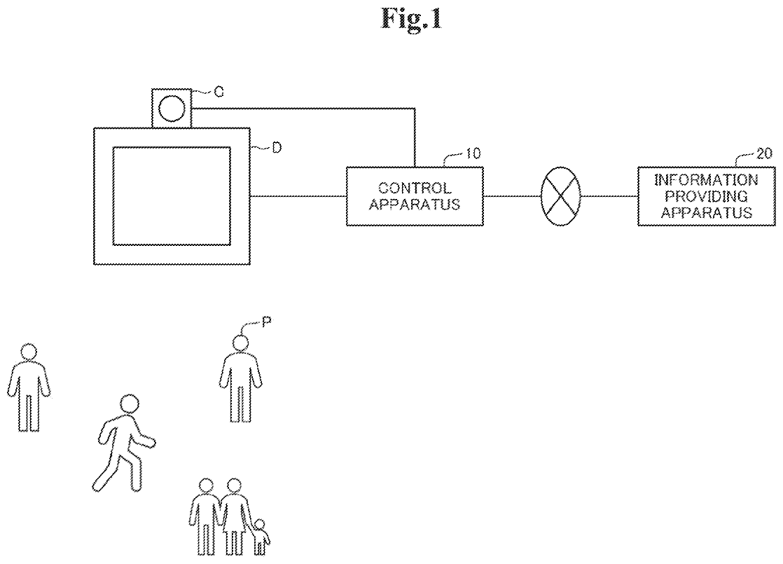

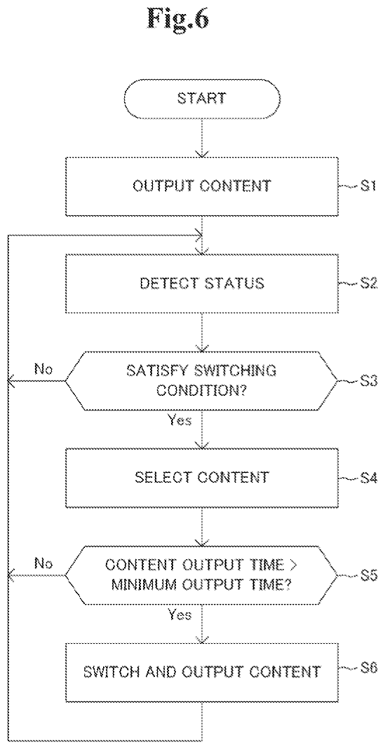

A first example embodiment of the present invention will be described with reference to FIGS. 1 to 6. FIGS. 1 to 5 are views for describing a configuration of a content display system, and FIG. 6 is a view for describing a processing operation of the content display system.

### [Configuration]

A content display system according to the present invention is for displaying content on a display medium and advertising a product and service by the content to a person. Although a description will be given in this example embodiment assuming a display medium is digital signage D, a display medium may be a projector that projects and displays content on a screen, and may be any medium.

As shown in FIG. 1, the content display system includes digital signage D serving as a display medium, and a control apparatus 10 controlling the output of content to display on the digital signage D. The content display system also includes a camera C capturing an image of the surroundings of the digital signage D. The digital signage D and the camera C are connected to a control apparatus 10. Moreover, the control apparatus 10 is connected to an information providing apparatus 20 via a network. The respective components will be described below.

The above digital signage D is installed on a street or in a facility. In particular, the digital signage D is arranged in a place where a user visiting the street or the facility can visually recognize. The digital signage D has a display that is a display screen, and outputs content so as to display on the display in accordance with an instruction by the control apparatus 10 as will be described later.

The camera C is installed above or around the digital signage D, and is arranged so as to capture an image (a moving image or a still image) of the surroundings of the digital signage D. In particular, the camera C is arranged so as to capture a predetermined range in a direction in which the display surface of the display of the digital signage D is oriented, that is, a predetermined range in front of the display surface of the display. Specifically, the camera C has an image capture range set so as to be able to capture a person P who visually recognizes the display. Then, the camera C transmits a captured image to the control apparatus 10.

The information providing apparatus 20 is an information processing apparatus which is installed on the Internet to provide various information used when the control apparatus 10 switches content to output from the digital signage D as will be described later. For example, the information providing apparatus 20 provides information on the environment, such as weather, temperature, humidity, ultraviolet information (for example, UV (Ultra-Violet) index), wind speed, and atmospheric pressure. The information providing apparatus 20 may be an apparatus that provides accurate time, or may be an apparatus that provides any other information.

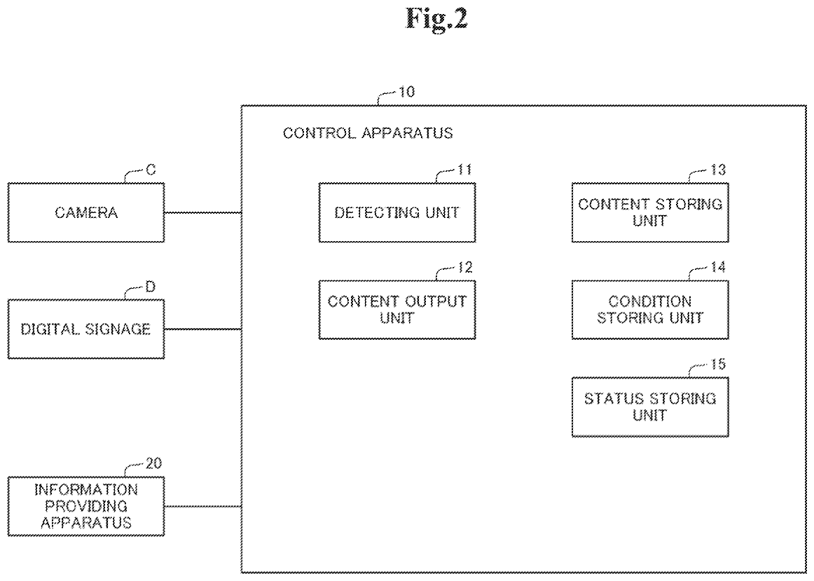

The control apparatus 10 is configured by one or a plurality of information processing apparatuses including an arithmetic logic unit and a storage unit. As shown in FIG. 2, the control apparatus 10 includes a detecting unit 11 and a content output unit 12. The functions of the detecting unit 11 and the content output unit 12 can be realized by the arithmetic logic unit executing a program for realizing the respective functions stored in the storage unit. The control apparatus 10 also includes a content storing unit 13, a condition storing unit 14, and a status storing unit 15. The content storing unit 13, the condition storing unit 14, and the status storing unit 15 are configured by the storage unit. Hereinafter, the respective components will be described in detail.

The detecting unit 11 has a function of detecting the status of a preset target while content is being output on the digital signage D. In particular, the detecting unit 11 sets the status of the surroundings of the digital signage D and the status of content output from the digital signage D as a target for detecting a status, and detects these statuses.

Here, the status of the surroundings of the digital signage D detected by the detecting unit 11 will be described in detail. First, the detecting unit 11 detects the current time as the status of the surroundings of the digital signage D based on time information set in the control apparatus 10. The detecting unit 11 may detect accurate time information from the abovementioned information providing apparatus 20.

Further, the detecting unit 11 acquires environmental information such as a weather forecast for an area where the digital signage D is installed from the abovementioned information providing apparatus 20, and detects the status of the environment of the surroundings of the digital signage D from the environmental information. For example, the detecting unit 11 detects weather, temperature, humidity, ultraviolet information (for example, UV (Ultra-Violet) index), wind speed and atmospheric pressure as the status of the environment of the surroundings the digital signage D. Then, the detecting unit 11 stores the detected status of the environment of the surroundings of the digital signage D into the status storing unit 15. The detecting unit 11 acquires environmental information from the information providing apparatus 20 at preset timings or at regular time intervals, and stores as the latest status of the environment of the surroundings of the digital signage D.

Further, the detecting unit 11 acquires an image captured by the abovementioned camera C, and detects the status of an object located around the digital signage D from the image. For example, the detecting unit 11 detects a person P as an object, and detects the number of the persons P and the attributes of the persons P. The attribute of a person P is an attribute that can be identified based on the movement of the person P and an attribute that can be identified based on the characteristic of the person P. Specifically, the detecting unit 11 detects a person P who is standing still and a person P who is looking at and visually recognizing the digital signage D as an attribute that can be identified based on the movement of the person P. Moreover, the detecting unit 11 detects the gender, age, facial expression, emotion and the like of a person P as an attribute that can be identified based on the characteristic of the person P. Then, the detecting unit 11 stores the status of a person P that is the detected status of an object around the digital signage D into the status storing unit 15.

Specifically, the detecting unit 11 extracts a person P in an image based on the movement, shape, color and the like of an object shown in the image, counts the number of the persons, and detects the movements of the extracted person P. Likewise, the detecting unit 11 extracts the face region of the extracted person P and detects a preset feature value, thereby detecting the gender, age, line of sight, facial expression and emotion of the person P. At this time, the gender and age of the person P can be detected by using the feature values of the respective parts such as the face and eyes of the person P detected from the image, the relation between the feature values of the respective parts, and the like. Moreover, the line of sight of the person P can be detected by using the orientation of the face and the orientation of the eyes of the person P detected from the image, and it can be detected whether the person is oriented in the direction of the digital signage D, that is, whether the person is visually recognizing the digital signage D. The detecting unit 11 further detects the line of sight of the person P and also detects a continuous time during which the person is visually recognizing the digital signage D. Moreover, the emotion of the person P can be detected by identifying an emotion corresponding to the facial expression detected from the feature value of the face region of the person P based on the facial expression.

Information detected by the detecting unit 11 as the status of a person P is not limited to the abovementioned information, and another status representing the status of a person P may be detected. Moreover, the detecting unit 11 may detect the status of any object, not limited to a person P, as the status of an object around the digital signage D. For example, in a case where the digital signage D is installed for a person P driving a vehicle, the detecting unit 11 may detect the status of vehicles traveling on a road around the digital signage D (the presence or absence of vehicles, the number of vehicles, the traveling direction, and so on).

Further, the detecting unit 11 detects the output status of content when the content is being output from the digital signage D. For example, the detecting unit 11 detects, as the output status of content, the playback time of the content, the ratio of the length of the played part to the length of the entire content, and whether or not the content has been played to the end.

The content output unit 12 outputs content from the digital signage D, and also performs a switching process of switching content to output in accordance with the status detected by the detecting unit 11 described above. The order of contents output from the digital signage D is previously set as a scenario. The scenario includes a phase representing a content output scene and a phase switching condition. To a phase, one or a plurality of contents that can be output in the scene of the phase belong. As a switching condition, a condition for switching from a state of outputting content in a certain phase to a state of outputting content in another phase is set. Moreover, a selection condition for selecting content to output is also set for each phase and is included in the scenario. The contents are previously stored in the content storing unit 13, and the switching conditions and the selection conditions are stored in the condition storing unit 14.

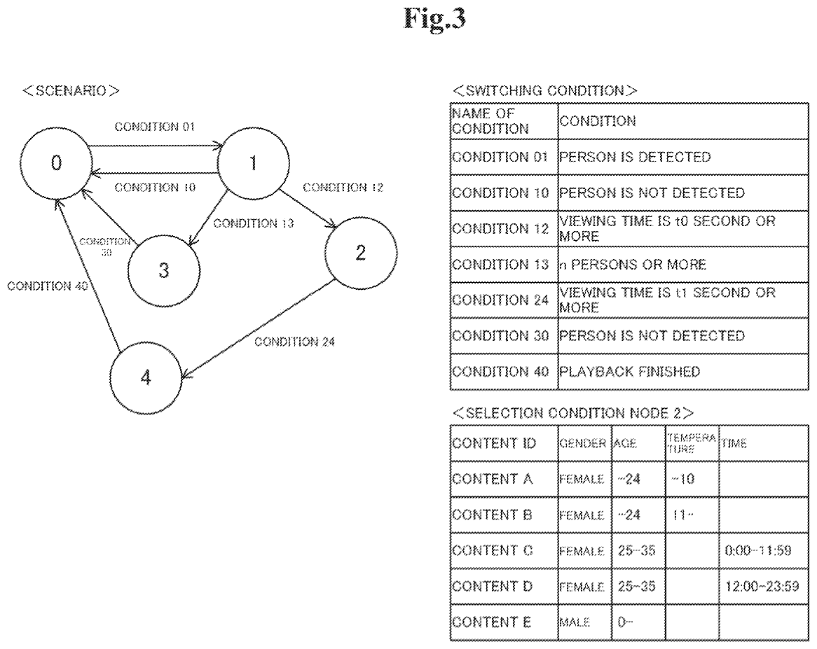

Here, an example of the abovementioned scenario will be described with reference to FIG. 3. In FIG. 3, content groups belonging to the respective phases described above are illustrated by nodes (0 to 4) marked with circles, and the switching conditions are illustrated by arrows between the nodes. Specifically, in the scenario shown in FIG. 3, firstly, it is set to, in a case where a status detected while content belonging to “Node 0” is being displayed in Phase 0 satisfies a switching condition “Condition 01”, shift to Phase 1 and display content belonging to “Node 1”. At this time, as shown in the upper right view of FIG. 3, “Person is Detected” is set in “Condition 01”, and it is set to, when the status of a person P is detected from an image captured with the camera C while the content belonging to “Node 0” is being played in Phase 0 and even one person P is detected, determine that “Condition 01” is satisfied and switch so as to shift to Phase 1 and output the content belonging to “Node 1”.

Further, in the scenario shown in FIG. 3, it is set to, in a case where a status detected while the content belonging to “Node 1” is being displayed in Phase 1 satisfies a switching condition “Condition 12”, shift to Phase 2 and display content belonging to “Node 2”. At this time, as shown in the upper right view of FIG. 3, “Viewing Time is t0 second or more” is set in “Condition 12”, and it is set to, when the status of a person P is detected from an image captured with the camera C while the content belonging to “Node 1” is being played in Phase 1 and it is detected that the line of sight of the person P is directed to the digital signage D for t0 second or more (for example, 3 seconds or more), determine that “Condition 12” is satisfied and switch so as to shift to Phase 2 and output the content belonging to “Node 2”.

As described above, in the scenario shown in FIG. 3, it is set that the content output unit 12 first performs a switching process of switching so as to shift from a state of outputting content belonging to “Node 0” in Phase 0 to Phase 1 and output content belonging to “Node 1” and, in addition to this, it is set that the content output unit 12 performs a switching process of switching so as to shift from a state of outputting the content belonging to “Node 1” in Phase 1 to Phase 2 and output content belonging to “Node 2”. That is to say, in this example embodiment, the content output unit 12 performs at least two content switching processes. At this time, “Condition 01” and “Condition 12”, which are switching conditions set for the two content switching processes, respectively, are set so as to be different from each other. Furthermore, through the two content switching processes, the state shifts to at least three different phases (content output scenes) and at least three different contents are displayed.

Further, in the scenario shown in FIG. 3, it is set to, in a case where a status detected while the content belonging to “Node 1” is being displayed in Phase 1 satisfies a switching condition “Condition 13”, shift to Phase 3 and display content belonging to “Node 3”. At this time, as shown in the upper right view of FIG. 3, “n Persons or More” is set in “Condition 13”, and it is set to, when the status of a person P is detected from an image captured with the camera C while the content belonging to “Node 1” is being played in Phase 1 and it is detected that the number of persons P is n or more (for example, three or more), determine that “Condition 13” is satisfied and switch so as to shift to Phase 3 and output the content belonging to “Node 3”.

As described above, in the scenario shown in FIG. 3, it is set that the content output unit 12 performs a switching process of switching from a state of outputting content belonging to “Node 1” in Phase 1 to output content belonging to “Node 2” or “Node 3”. That is to say, a plurality of different switching conditions “Condition 12” and “Condition 13” are set for the switching process performed by the content output unit 12 while the content belonging to “Node 1” is being displayed in Phase 1 and, when either of the switching conditions is satisfied, the phase is shifted to a phase corresponding to the satisfied switching condition, and the content is switched to content belonging to a node corresponding to the phase.

In the scenario shown in FIG. 3, “Condition 10” is further set as a switching condition while the content belonging to “Node 1” is being displayed in Phase 1, and it is set to, in a case where the detected status satisfies the switching condition “Condition 10”, shift to Phase 0 and display the content belonging to “Node 0”. At this time, as shown in the upper right view of FIG. 3, “Person is Not Detected” is set in “Condition 10”, and it is set to, in a case where no person P is detected any more from the image captured with the camera C while the content belonging to “Node 1” is being played in Phase 1, determine that “Condition 10” is satisfied and switch so as to shift to Phase 0 and output the content belonging to “Node 0”.

As described above, three different switching conditions are set for the switching process performed by the content output unit 12 while displaying the content belonging to “Node 1” in Phase 1. Meanwhile, more switching conditions may be set for one switching process.

Further, in the scenario shown in FIG. 3, it is set to, in a case where a status detected while content belonging to “Node 3” is being displayed in Phase 3 satisfies a switching condition “Condition 30”, shift to Phase 0 and display the content belonging to “Node 0”. At this time, as shown in the upper right view of FIG. 3, “Person is Not Detected” is set in “Condition 30”, and it is set to, in a case where no person P is detected any more from the image captured with the camera C while the content belonging to “Node 3” is being played in Phase 3, determine that “Condition 30” is satisfied and switch so as to shift to Phase 0 and output the content belonging to “Node 0”.

As described above, in the scenario shown in FIG. 3, it is set that the content output unit 12 performs a switching process of switching from a state of outputting the content belonging to “Node 3” in Phase 3 so as to output the content belonging to “Node 0” having already been output before or after another switching process. That is to say, in this case, it is set to perform a switching process of switching from the state of outputting the content belonging to “Node 3” in Phase 3 so as to output the content belonging to “Node 0” having already been output before the switching process between Phase 0 and Phase 1. Likewise, the abovementioned switching process of returning from outputting the content of “Node 1” in Phase 1 to outputting the content of “Node 0” in Phase 0 is also set to perform a switching process of switching from the state of outputting the content belonging to “Node 1” so as to output the content belonging to “Node 0” having already been output before or after another switching process.

Further, in the scenario shown in FIG. 3, one or a plurality of contents belong to a “Node” corresponding to each phase, and a condition for selecting content to output is set for each “Node”. As an example, in the scenario shown in FIG. 3, in a case where a status detected while content belonging to “Node 1” is being displayed satisfies the switching condition “Condition 12”, the phase is switched to shift to Phase 2 and display content belonging to “Node 2”. Meanwhile, a selection condition for selecting, in a case where there are a plurality of contents belonging to “Node 2”, which content from among the contents is previously set. At this time, the selection condition includes information in which the condition corresponding to the status detected by the detecting unit 11 described above is associated with content.

For example, a selection condition set corresponding to “Node 2” in Phase 2 is set as shown in the lower right view of FIG. 3. In this example, five contents (A to E) belong to “Node 2”, and a condition for selecting each content is set. That is to say, it is set for “Content A” that a status detected by the detecting unit 11 is “person's gender: female, person's age: 24 years old or younger, temperature: 10° C. or lower”, and it is set for “Content C” that a status detected by the detecting unit 11 is “person's gender: female, person's age: 25 to 35 years old, time: 12:00 to 23:59”. Therefore, in a case where it is determined to switch so as to shift to Phase 2 and display the content belonging to “Node 2” in the switching process by the content output unit 12, content associated with a condition satisfied by the content detected by the detecting unit 11 is selected from among the selection conditions set for “Node 2”.

As described above, in the switching process, the content output unit 12 switches content to output from the digital signage D in accordance with a status detected by the detecting unit 11, a switching condition and a selection condition. Meanwhile, the content output unit 12 switches in accordance with the output time of content. Specifically, the detecting unit 11 detects the output time of content while the content output unit 12 is outputting the content from the digital signage D. Then, the content output unit 12 retrieves a preset minimum output time of the content, compares the detected output time with the minimum output time, and waits without switching the content until the output time of the content reaches the minimum output time. That is to say, in a case where the detected status satisfies the switching condition as described above, the content output unit 12 determines to shift the phase in the above manner and switches the content to output after the output time of the content reaches the minimum output time. The minimum output time of content may be uniformly set, or may be set for each content or each node. Meanwhile, no minimum output time of content may be set.

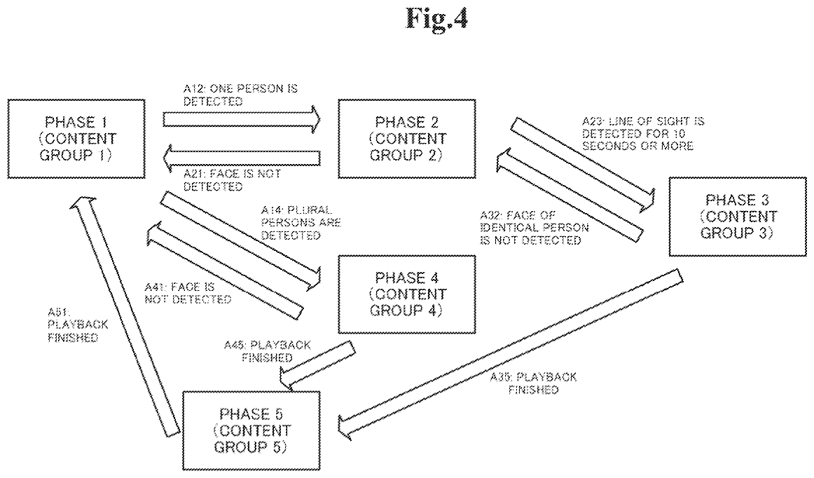

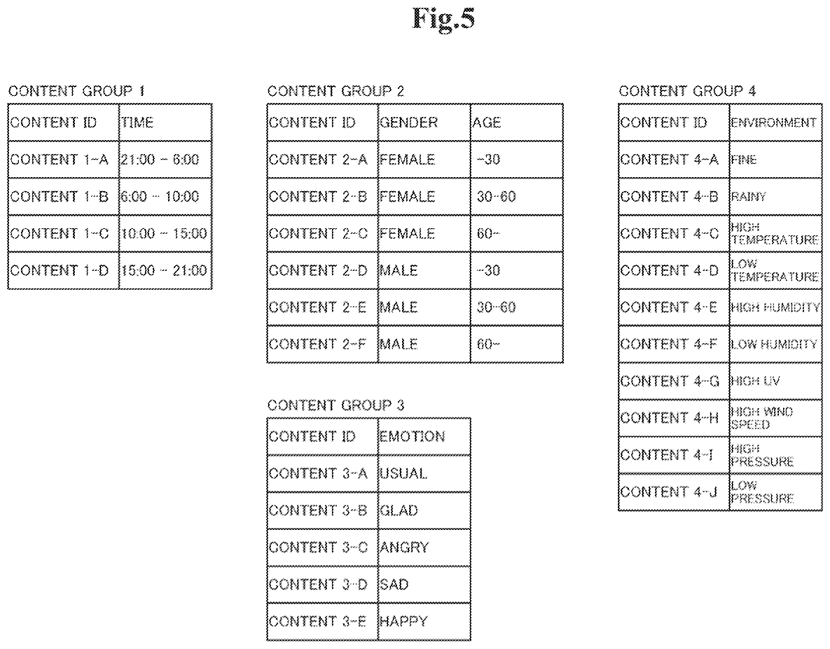

Subsequently, another example of the switching condition and the selection condition will be described with reference to FIGS. 4 to 5. In the scenario example shown in FIGS. 4 to 5, content groups 1 to 5 of the respective Phases 1 to 5 are prepared. The scenario example shows that a switching condition as shown in FIG. 4 and a selection condition as shown in FIG. 5 are set for each phase and content to output is switched in accordance with the conditions.

First, content of the content group 1 is output to the digital signage D in Phase 1. A selection condition as shown in FIG. 5 is set for the content group 1. In this example, time corresponding to each of the contents 1-A to 1-D belonging to the content group 1 is set as the selection condition. Therefore, content associated with a status corresponding to the current time detected by the detecting unit 11 as a selection condition is selected from the content group 1 and output from the digital signage D. For example, in a case where the current time is “8 O'clock”, “Content 1-B” is selected and output.

Two switching conditions A12 and A14 are set for Phase 1. Since “One Person is Detected” is set as the switching condition A12, it is determined that the switching condition A12 is satisfied when only one person P is detected from an image captured with the camera C while the content 1 is being displayed in Phase 1, and the phase is switched so as to shift to Phase 2 and output content belonging to the content group 2. Moreover, since “Plural Persons are Detected” is set as the switching condition A14, it is determined that the switching condition A14 is satisfied when a plurality of persons P are detected from an image captured with the camera C while the content 1 is being displayed in Phase 1, and the phase is switched so as to shift to Phase 4 and output content belonging to the content group 4.

In a case where it is determined to shift to phase 2 and output content of the content group 2, for the content group 2, there is a set condition for selecting content to output after the switching from among contents 2-A to 2-F belonging to the content group 2. In this example, as shown in FIG. 5, gender and age are set as the selection condition, which are two personal attributes representing the status of a person corresponding to each of the contents 2-A to 2-F belonging to the content group 2. Therefore, content associated with an attribute corresponding to the attribute of a person P shown in the current image detected by the detecting unit 11 as the selection condition is selected from the content group 2 and is output from the digital signage D. For example, in a case where the gender of a person P shown in the current image is “Female” and the age of the person P is “30 to 60 years old”, “Content 2-B” is selected and output.

Further, in a case where it is determined to shift to phase 4 and output content of the content group 4, for the content group 4, there is a set condition for selecting content to output after the switching from among contents 4-A to 4-J belonging to the content group 4. In this example, as shown in FIG. 5, an environmental status corresponding to each of the contents 4-A to 4-J belonging to the content group 4 is set as the selection condition. Therefore, content associated with a status corresponding to the current environmental status detected by the detecting unit 11 as the selection condition is selected from the content group 4 and is output from the digital signage D. For example, in a case where, of the current environment, humidity is higher than a certain threshold value, that is, in the case of “High Humidity”, “Content 4-E” is selected and output. In a case where the current UV index is higher than a certain threshold value, that is, in the case of “High UV”, “Content 4-G” is selected and output.

Two switching conditions A23 and A21 are set for Phase 2. “Line of Sight is Detected for 10 Seconds” is set as the switching condition A23. Therefore, when the status of a person P is detected from an image captured with the camera C while the content of the content group 2 is being displayed in Phase 2 and it is detected that the line of sight of the person P is oriented to the digital signage D for 10 seconds or more, it is determined that the switching condition A23 is satisfied, and the phase is switched so as to shift to Phase 3 and output content belonging to the content group 3. Moreover, since “Face is Not Detected” is set as the switching condition A21, it is determined that the switching condition A21 is satisfied when no person P is detected from an image captured with the camera C while the content of the content group 2 is being displayed in Phase 2, and the phase is switched so as to shift to Phase 1 and output the content belonging to the content group 1.

In a case where it is determined to shift to Phase 3 and output the content of the content group 3, for the content group 3, there is a set condition for selecting content to output after the switching from among contents 3-A to 3-E belonging to the content group 3. In this example, as shown in FIG. 5, emotion is set as the selection condition, which is a personal attribute representing the status of a person corresponding to each of the contents 3-A to 3-E belonging to the content group 3. Therefore, content associated with an attribute corresponding to the attribute of a person P shown in the current image detected by the detecting unit 11 as the selection condition is selected from the content group 3 and is output from the digital signage D. For example, in a case where the emotion of a person P shown in the current image is “happy”, “Content 3-E” is selected and output.

Further, in a case where it is determined to shift to Phase 1 and output the content of the content group 1, for the content group 1, there is a set condition for selecting content to output after the switching from among the contents 1-A to 1-D belonging to the content group 1. In this example, as shown in FIG. 5, time corresponding to each of the contents 1-A to 1-E belonging to the content group 1 is set as the selection condition. Therefore, content associated with time corresponding to the current time detected by the detecting unit 11 as the selection condition is selected from the content group 1 and is output from the digital signage D. For example, in a case where the current time is “12 O'clock”, “Content 1-C” is selected and output.

Subsequently, two switching conditions A35 and A32 are set for Phase 3. “Playback Finished” is set as the switching condition A35. Therefore, when the playback status of the content of the content group 3 is detected while the content is being displayed in Phase 3 and playback of the content is finished, it is determined that the switching condition A35 is satisfied, and the phase is switched so as to shift to Phase 5 and output content belonging to the content group 5. Since only one content belongs to the content group 5, the content is output. Moreover, since “Face of Identical Person is Not Detected” is set as the switching condition A32, it is determined that the switching condition A32 is satisfied when an identical person P having been detected for a certain time period is not detected any more from an image captured with the camera C while the content of the content group 3 is being displayed in Phase 3, and the phase is switched so as to shift to Phase 2 and output the content belonging to the content group 2.

Subsequently, two switching conditions A45 and A41 are set for Phase 4. “Playback Finished” is set as the switching condition A45. Therefore, when the playback status of the content of the content group 4 is detected while the content is being displayed in Phase 4 and playback of the content is finished, it is determined that the switching condition A45 is satisfied, and the phase is switched so as to shift to Phase 5 and output content belonging to the content group 5. Since only one content belongs to the content group 5, the content is output. Moreover, since “Face is Not Detected” is set as the switching condition A41, it is determined that the switching condition A41 is satisfied when a person P is not detected any more from an image captured with the camera C while the content of the content group 4 is being displayed in Phase 4, and the phase is switched so as to shift to Phase 1 and output the content belonging to the content group 1.

Subsequently, a switching condition A51 is set for Phase 5, and “Playback is finished” is set as the switching condition A51. Therefore, when the playback status of the content of the content group 5 is detected while the content is being displayed in Phase 5 and playback of the content is finished, it is determined that the switching condition A51 is satisfied, and the phase is switched so as to shift to Phase 1 and output content belonging to the content group 1.

### [Operation]

Next, an operation of the above content display system will be described mainly with reference to a flowchart of FIG. 6. It is assumed that the content display system is set so as to display content in accordance with a preset scenario as shown in FIG. 4, for example. For this, the control apparatus 10 stores content to output in accordance with the set scenario in the content storing unit 13, and stores a condition for switching and a condition for selecting content to output in accordance with the set scenario in the condition storing unit 14. The control apparatus 10 detects the status of the surroundings of the digital signage D, such as environment information and stores information of the status into the status storing unit 15 in advance as necessary.

The control apparatus 10 outputs first content of the set scenario so as to display on the digital signage D (step S1). In a case where content to output first has been determined, the control apparatus 10 outputs the content. In a case where a selection condition has been set for content to output first, the control apparatus 10 detects the current status of the surroundings of the digital signage D, and selects and outputs content corresponding to the status.

Subsequently, while outputting the content to the digital signage D, the control apparatus 10 detects the current status of the surroundings of the digital signage D and the current output status of the content (step S2). Then, the control apparatus 10 retrieves a switching condition set corresponding to the current output status of the content, and checks whether the detected status satisfies the switching condition (step S3). In a case where the detected status satisfies the switching condition (step S3, Yes), the control apparatus 10 determines to output other content belonging to a next phase set in the scenario. At this time, in a case where a condition for selecting next content is set, the control apparatus 10 retrieves the selection condition, and selects content whose detected status corresponds to the selection condition (step S4). Meanwhile, in a case where there is only one content of the next phase, the control apparatus 10 selects the content.

At this time, the control apparatus 10 checks an output time, which is the detected output status of the first content, and checks whether or not the output time has passed a preset minimum output time (step S5). Then, in a case where the output time of the first content has passed the minimum output time, the control apparatus 10 switches from the first content being output on the digital signage D to output the selected next content (step S6). Thus, a first switching process of switching the output of content is completed.

Subsequently, while outputting the content selected in the first switching process as described above, the control apparatus 10 detects the current status of the surroundings of the digital signage D and the current output status of the content (step S2). Then, the control apparatus 10 retrieves a switching condition set corresponding to the current output status of the content, and checks whether the detected status satisfies the switching condition (step S3). This switching condition is different from the switching condition in the first switching process described above. In a case where the detected status satisfies the switching condition (step S3, Yes), the control apparatus 10 determines to output content belonging to a further next phase set in the scenario. At this time, in a case where a condition for selecting the further next content is set, the control apparatus 10 retrieves the selection condition, and selects content whose detected status corresponds to the selection condition (step S4).

At this time, the control apparatus 10 checks an output time, which is the detected output status of the first content, and checks whether or not the output time has passed a preset minimum output time (step S5). Then, in a case where the output time of the first content has passed the minimum output time, the control apparatus 10 switches from the first content being output on the digital signage D to output the selected next content (step S6). Thus, a second switching process of switching the output of content is completed. Then, the control apparatus 10 repeatedly executes a switching process in the same manner as described above in accordance with the set scenario.

As described above, the content output system according to the present invention switches the output of content under different switching conditions in at least two switching processes. Therefore, it is possible to output various types of content in accordance with the respective statuses, and it is possible to increase an advertising effect by content.

In the content output system according to the present invention, a plurality of switching conditions are set for a switching process, and a selection condition for selecting content to output from among a plurality of contents is also set. Therefore, it is possible to output more appropriate content in accordance with a status, and it is possible to further increase an advertising effect by content.

### Second Example Embodiment

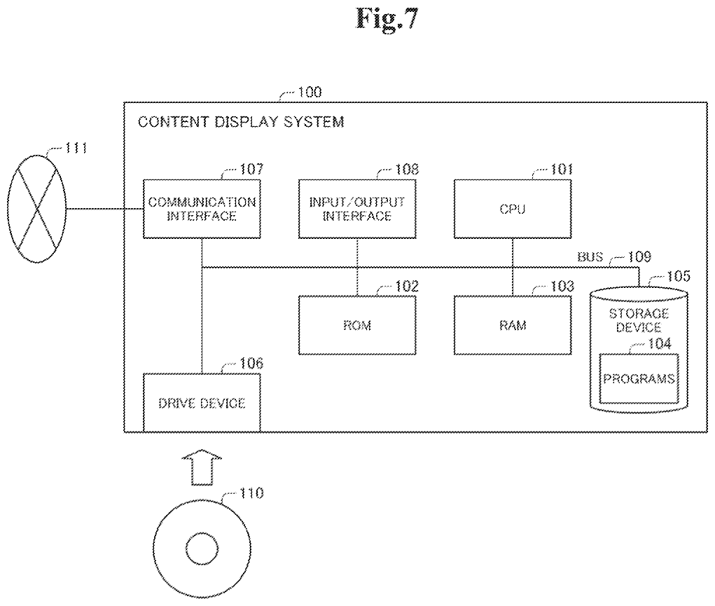

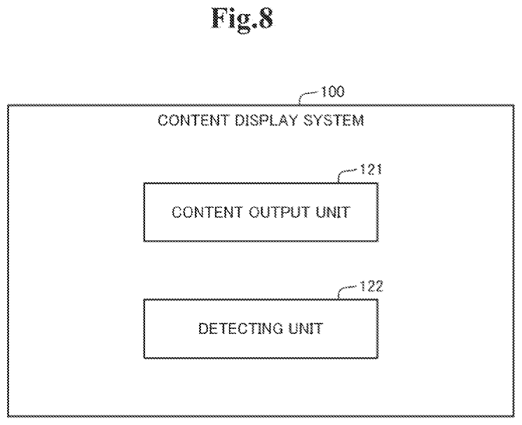

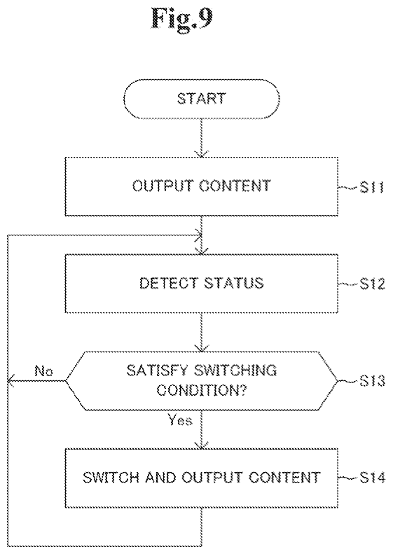

Next, a second example embodiment of the present invention will be described with reference to FIGS. 7 to 9. FIGS. 7 to 8 are block diagrams showing a configuration of a content display system in a second example embodiment, and FIG. 9 is a flowchart showing an operation of the content display system. This example embodiment shows the overview of the configurations of the content display system described in the above example embodiment and a content display method by the system.

First, with reference to FIG. 7, a hardware configuration of a content display system 100 in this example embodiment will be described. The content display system 100 is configured by one or a plurality of general information processing apparatuses and, as an example, includes the following hardware configuration;

a CPU (Central Processing Unit) 101 (arithmetic logic unit),

a ROM (Read Only Memory) 102 (storage unit),

a RAM (Random Access Memory) 103 (storage unit),

programs 104 loaded to the RAM 103,

a storage unit 105 for storing the programs 104,

a drive device 106 reading from and writing into a storage medium 110 outside the information processing apparatus,

a communication interface 107 connected to a communication network 111 outside the information processing apparatus,

an input/output interface 108 inputting and outputting data, and

a bus 109 connecting the respective components.

Then, the content display system 100 can structure and include a content output unit 121 and a detecting unit 122 shown in FIG. 8 by acquisition and execution of the programs 104 by the CPU 101. The programs 104 are, for example, previously stored in the storage device 105 and the ROM 102 and loaded to the RAM 103 and executed by the CPU 101 as necessary. The programs 104 may be supplied to the CPU 101 via the communication network 111, or may be previously stored in the storage medium 110 and retrieved and supplied to the CPU 101 by the drive device 106. The abovementioned content output unit 121 and detecting unit 122 may be structured by an electronic circuit.

FIG. 7 shows an example of the hardware configuration of the information processing apparatus serving as the content display system 100, and the hardware configuration of the information processing apparatus is not limited to the above case. For example, the information processing apparatus may include part of the above configuration, such as excluding the drive device 106.

The content display system 100 executes a content display method shown in the flowchart of FIG. 9 by the functions of the content output unit 121 and the detecting unit 122 structured by the programs as described above.

As shown in FIG. 9, the content display system 100 outputs content from a display medium (step S11) and also detects a status of a preset target (step S12), when the status of the target satisfies a preset switching condition (step S13, Yes), performs a switching process of switching the content output from the display medium to other content (step S14), and furthermore, in the case of performing the switching process multiple times, performs at least two switching process for which different switching conditions are set (repetition of steps S12 to S14).

According to the present invention, with the configuration as described above, the output of content is switched under different conditions in at least two switching processes. Therefore, it is possible to output various types of content in accordance with the respective statuses, and it is possible to increase an advertising effect by content.

### <Supplementary Notes>

The whole or part of the example embodiments disclosed above can be described as the following supplementary notes. Below, the outline of the configurations of a content display method, a content display system, and a program according to the present invention will be described. However, the present invention is not limited to the following configurations.

### (Supplementary Note 1)

A content display method comprising:

outputting content from a display medium and also detecting a status of a preset target;

in a case where the status of the target satisfies a preset switching condition, performing a switching process to switch the content output from the display medium to other content; and furthermore

in a case of performing a plurality of switching processes, performing at least two switching processes for which different switching conditions are set.

### (Supplementary Note 2)

The content display method according to Supplementary Note 1, wherein

at least one of the switching processes is to, in a case where the status of the target satisfies the switching condition, output content output from the display medium before or after switching content in the other switching process as the other content after the switching from the display medium.

### (Supplementary Note 3)

The content display method according to Supplementary Note 1 or 2, wherein

at least one of the switching processes is to, in a case where a plurality of different switching conditions are set and the status of the target satisfies the respective switching conditions, output other contents different from each other set to be corresponding to the respective switching conditions from the display medium.

### (Supplementary Note 4)

The content display method according to any of Supplementary Notes 1 to 3, wherein

at least one of the switching processes is to, at a time of switching the content output from the display medium to the other content, select the other content in accordance with the status of the target and output the other content from the display medium.

### (Supplementary Note 5)

The content display method according to Supplementary Note 4, wherein

at least one of the switching processes is to, in a case where the status of the target satisfies the switching condition, determine to switch to any content of a content group including a plurality of contents associated to be corresponding to the switching condition, and select content satisfying a selection condition in which the status of the target is set by a criterion different from the switching condition as the other content from the content group and output the content from the display medium.

### (Supplementary Note 6)

The content display method according to any of Supplementary Notes 1 to 5, wherein

at least one of the switching processes is to, in a case where the status of the target satisfies the switching condition, switch so as to output the other content after an output time of the content output from the display medium reaches a preset minimum output time.

### (Supplementary Note 7)

The content display method according to any of Supplementary Notes 1 to 6, comprising

detecting, as the status of the target, a status of surroundings of the display medium while outputting the content from the display medium.

### (Supplementary Note 8)

The content display method according to Supplementary Note 7, comprising

detecting, as the status of the target, a status of a surrounding environment of the display medium while outputting the content from the display medium.

### (Supplementary Note 9)

The content display method according to Supplementary Note 7 or 8, comprising

detecting, as the status of the target, a status of an object located around the display medium while outputting the content from the display medium.

### (Supplementary Note 10)

The content display method according to any of Supplementary Notes 7 to 9, comprising

detecting, as the status of the target, a status of a person located around the display medium while outputting the content from the display medium.

### (Supplementary Note 11)

The content display method according to any of Supplementary Notes 7 to 10, comprising

detecting, as the status of the target, an attribute of a person located around the display medium while outputting the content from the display medium.

### (Supplementary Note 12)

The content display method according to any of Supplementary Notes 1 to 11, comprising

detecting, as the status of the target, an output status of the content while outputting the content from the display medium.

### (Supplementary Note 13)

A content display system comprising:

a content output unit configured to output content from a display medium; and

a detecting unit configured to detect a status of a preset target, wherein

the content output unit is configured to, in a case where the status of the target satisfies a preset switching condition, perform a switching process to switch the content output from the display medium to other content, and furthermore, in a case of performing a plurality of switching processes, perform at least switching processes for which different switching conditions are set.

### (Supplementary Note 14)

The content display system according to Supplementary Note 13, wherein

the content output unit is configured to, in at least one the switching processes, in a case where the status of the target satisfies the switching condition, output content output from the display medium before or after switching content in the other switching process as the other content after the switching from the display medium.

### (Supplementary Note 15)

The content display system according to Supplementary Note 13 or 14, wherein

the content output unit is configured to, in at least one of the switching processes, in a case where a plurality of different switching conditions are set and the status of the target satisfies the respective switching conditions, output other contents different from each other set to be corresponding to the respective switching conditions from the display medium.

### (Supplementary Note 16)

The content display system according to any of Supplementary Notes 13 to 15, wherein

the content output unit is configured to, in at least one of the switching processes, at a time of switching the content output from the display medium to the other content, select the other content in accordance with the status of the target and output the other content from the display medium.

### (Supplementary Note 16.1)

The content display system according to claim 16, wherein

the content output unit is configured to, in at least one of the switching processes, in a case where the status of the target satisfies the switching condition, determine to switch to any content of a content group including a plurality of contents associated to be corresponding to the switching condition, and select content satisfying a selection condition in which the status of the target is set by a criterion different from the switching condition as the other content from the content group and output the content from the display medium.

### (Supplementary Note 17)

The content display system according to any of Supplementary Notes 13 to 16, wherein

the content output unit is configured to, in at least one of the switching processes, in a case where the status of the target satisfies the switching condition, switch so as to output the other content after an output time of the content output from the display medium reaches a preset minimum output time.

### (Supplementary Note 18)

The content display system according to any of Supplementary Notes 13 to 17, wherein

the detecting unit is configured to detect, as the status of the target, a status of surroundings of the display medium while the content is being output from the display medium.

### (Supplementary Note 18.1)

The content display system according to Supplementary Note 18, wherein

the detecting unit is configured to detect, as the status of the target, a status of a surrounding environment of the display medium while outputting the content from the display medium.

### (Supplementary Note 18.2)

The content display system according to Supplementary Note 18, wherein

the detecting unit is configured to detect, as the status of the target, a status of an object located around the display medium while outputting the content from the display medium.

### (Supplementary Note 18.3)

The content display system according to Supplementary Note 18, wherein

the detecting unit is configured to detect, as the status of the target, a status of a person located around the display medium while outputting the content from the display medium.

### (Supplementary Note 18.4)

The content display system according to Supplementary Note 18, wherein

the detecting unit is configured to detect, as the status of the target, an attribute of a person located around the display medium while outputting the content from the display medium.

### (Supplementary Note 19)

The content display system according to any of Supplementary Notes 13 to 18, wherein

the detecting unit is configured to detect, as the status of the target, an output status of the content while the content is being output from the display medium.

### (Supplementary Note 20)

A computer program comprising instructions for causing a processor of an information processing apparatus to execute:

outputting content from a display medium and also detecting a status of a preset target;

in a case where the status of the target satisfies a preset switching condition, performing a switching process to switch the content output from the display medium to other content; and furthermore

in a case of performing a plurality of switching processes, performing at least two switching processes for which different switching conditions are set.

### (Supplementary Note 21)

A content display method comprising:

outputting content from a display medium and also detecting a status of a preset target; and

in a case where the status of the target satisfies a preset switching condition, performing a switching process to switch the content output from the display medium to other content,

wherein the switching process is to, in a case where the status of the target satisfies the switching condition, switch so as to output the other content after an output time of the content output from the display medium reaches a preset minimum output time.

### (Supplementary Note 22)

A content display system comprising:

a content output unit configured to output content from a display medium; and

a detecting unit configured to detect a status of a preset target, wherein:

the content output unit is configured to, in a case where the status of the target satisfies a preset switching condition, perform a switching process to switch the content output from the display medium to other content; and

the switching process is to, in a case where the status of the target satisfies the switching condition, switch so as to output the other content after an output time of the content output from the display medium reaches a preset minimum output time.

### (Supplementary Note 23)

A computer program comprising instructions for causing a processor of an information processing apparatus to execute:

outputting content from a display medium and also detecting a status of a preset target; and

in a case where the status of the target satisfies a preset switching condition, performing a switching process to switch the content output from the display medium to other content,

wherein the switching process is to, in a case where the status of the target satisfies the switching condition, switch so as to output the other content after an output time of the content output from the display medium reaches a preset minimum output time.

### (Supplementary Note 24)

A content display method comprising:

outputting content from a display medium and also detecting a status of a preset target; and

in a case where the status of the target satisfies a preset switching condition, performing a switching process to switch the content output from the display medium to other content,

wherein the switching process is to, at a time of switching the content output from the display medium to the other content, select the other content in accordance with the status of the target and output the other content from the display medium.

### (Supplementary Note 25)

A content display system comprising:

a content output unit configured to output content from a display medium; and

a detecting unit configured to detect a status of a preset target, wherein:

the content output unit is configured to, in a case where the status of the target satisfies a preset switching condition, perform a switching process to switch the content output from the display medium to other content; and

the switching process is to, at a time of switching the content output from the display medium to the other content, select the other content in accordance with the status of the target and output the other content from the display medium.

### (Supplementary Note 26)

A computer program comprising instructions for causing a processor of an information processing apparatus to execute:

outputting content from a display medium and also detecting a status of a preset target; and

in a case where the status of the target satisfies a preset switching condition, performing a switching process to switch the content output from the display medium to other content,

wherein the switching process is to, at a time of switching the content output from the display medium to the other content, select the other content in accordance with the status of the target and output the other content from the display medium.

The abovementioned programs can be stored by using various types of non-transitory computer-readable mediums and supplied to a computer. The non-transitory computer-readable mediums include various types of tangible storage mediums. Examples of the non-transitory computer-readable mediums include a magnetic recording medium (for example, a flexible disk, a magnetic tape, a hard disk), a magnetooptical recording medium (for example, a magnetooptical disk), a CD-ROM (Read Only Memory), a CD-R, a CD-R/W, and a semiconductor memory (for example, a mask ROM, a Programmable ROM), an EPROM (Erasable PROM), a flash ROM, a RAM (Random Access Memory)). Moreover, the programs may be supplied to a computer by various types of transitory computer-readable mediums. Examples of the transitory computer-readable mediums include an electric signal, an optical signal, and an electromagnetic wave. The transitory computer-readable medium can supply the programs to a computer via a wired communication channel such as an electric wire and an optical fiber, or a wireless communication channel.

Although the present invention has been described above with reference to the example embodiments and so on, the present invention is not limited to the above example embodiments. The configurations and details of the present invention can be changed in various manners that can be understood by one skilled in the art within the scope of the present invention. Moreover, at least one function or more among the functions of the detecting unit, the content display unit, the content storing unit, the condition storing unit, and the status storing unit described above may be executed by an information processing apparatus installed in any place on network and connected, that is, may be executed on so-called cloud computing.

### DESCRIPTION OF NUMERALS

10 control apparatus
11 detecting unit
12 content output unit
13 content storing unit
14 condition storing unit
15 status storing unit
20 information providing apparatus
C camera
D digital signage
P person
100 content display system
101 CPU
102 ROM
103 RAM
104 programs
105 storage device
106 drive device
107 communication interface
108 input/output interface
109 bus
110 storage medium
111 communication network
121 content output unit
122 detecting unit

What is claimed is:

1. A content display method comprising:
outputting content from a display medium and also detecting a status of a preset target;
in a case where the status of the target satisfies a preset switching condition, performing a switching process to switch the content output from the display medium to other content; and furthermore
in a case of performing a plurality of switching processes, performing at least two switching processes for which different switching conditions are set.

2. The content display method according to claim 1, wherein
at least one of the switching processes is to, in a case where the status of the target satisfies the switching condition, output content output from the display medium before or after switching content in the other switching process as the other content after the switching from the display medium.

3. The content display method according to claim 1, wherein
at least one of the switching processes is to, in a case where a plurality of different switching conditions are set and the status of the target satisfies the respective switching conditions, output other contents different from each other set to be corresponding to the respective switching conditions from the display medium.

4. The content display method according to claim 1, wherein
at least one of the switching processes is to, at a time of switching the content output from the display medium to the other content, select the other content in accordance with the status of the target and output the other content from the display medium.

5. The content display method according to claim 4, wherein
at least one of the switching processes is to, in a case where the status of the target satisfies the switching condition, determine to switch to any content of a content group including a plurality of contents associated to be corresponding to the switching condition, and select content satisfying a selection condition in which the status of the target is set by a criterion different from the switching condition as the other content from the content group and output the content from the display medium.

6. The content display method according to claim 1, wherein
at least one of the switching processes is to, in a case where the status of the target satisfies the switching condition, switch so as to output the other content after an output time of the content output from the display medium reaches a preset minimum output time.

7. The content display method according to claim 1, comprising
detecting, as the status of the target, a status of surroundings of the display medium while outputting the content from the display medium.

8. The content display method according to claim 7, comprising
detecting, as the status of the target, a status of a surrounding environment of the display medium while outputting the content from the display medium.

9. The content display method according to claim 7, comprising
detecting, as the status of the target, a status of an object located around the display medium while outputting the content from the display medium.

10. The content display method according to claim 7, comprising
detecting, as the status of the target, a status of a person located around the display medium while outputting the content from the display medium.

11. The content display method according to claim 7, comprising
detecting, as the status of the target, an attribute of a person located around the display medium while outputting the content from the display medium.

12. The content display method according to claim 1, comprising
detecting, as the status of the target, an output status of the content while outputting the content from the display medium.

13. A content display system comprising:
at least one memory configured to store instructions; and
at least one processor configured to execute the instructions to:
output content from a display medium,
and also detect a status of a preset target; and
in a case where the status of the target satisfies a preset switching condition, perform a switching process to switch the content output from the display medium to other content, and furthermore, in a case of performing a plurality of switching processes, perform at least switching processes for which different switching conditions are set.

14. The content display system according to claim 13, wherein the at least one processor is configured to execute the instructions to
in at least one the switching processes, in a case where the status of the target satisfies the switching condition, output content output from the display medium before or after switching content in the other switching process as the other content after the switching from the display medium.

15. The content display system according to claim 13, wherein the at least one processor is configured to execute the instructions to
in at least one of the switching processes, in a case where a plurality of different switching conditions are set and the status of the target satisfies the respective switching conditions, output other contents different from each other set to be corresponding to the respective switching conditions from the display medium.

16. The content display system according to claim 13, wherein the at least one processor is configured to execute the instructions to
in at least one of the switching processes, at a time of switching the content output from the display medium to the other content, select the other content in accordance with the status of the target and output the other content from the display medium.

17. The content display system according to claim 13, wherein the at least one processor is configured to execute the instructions to
in at least one of the switching processes, in a case where the status of the target satisfies the switching condition, switch so as to output the other content after an output time of the content output from the display medium reaches a preset minimum output time.

18. The content display system according to claim 13, wherein the at least one processor is configured to execute the instructions to
detect, as the status of the target, a status of surroundings of the display medium while the content is being output from the display medium.

19. The content display system according to claim 13, wherein the at least one processor is configured to execute the instructions to
detect, as the status of the target, an output status of the content while the content is being output from the display medium.

20. A non-transitory computer-readable storage medium having a computer program stored therein, the computer program comprising instructions for causing a processor of an information processing apparatus to execute:
outputting content from a display medium and also detecting a status of a preset target;
in a case where the status of the target satisfies a preset switching condition, performing a switching process to switch the content output from the display medium to other content; and furthermore
in a case of performing a plurality of switching processes, performing at least two switching processes for which different switching conditions are set.
